(19) United States
(12) Patent Application Publication
(10) Pub. No.: US 2010/0322617 A1
(43) Pub. Date: Dec. 23, 2010

(54) Multimedia multifunctional photo kiosk combination device

(76) Inventor: Hsien-Rong Liang, Taipei City (TW)

Correspondence Address: Muncy, Geissler, Olds & Lowe, PLLC, 4000 Legato Road, Suite 310, FAIRFAX, VA, 22033, US

(21) Appl. No.: 11/976,728

(22) Filed: Oct. 26, 2007

(51) Int. Cl. G03D 13/00

(52) U.S. Cl. 396/661

(57) ABSTRACT

The present invention provides a multimedia multifunctional photo kiosk combination device, wherein a multimedia device is structured from a display interface and an access device.

The access device is structured from a housing and a connector module, and the connector module is structured from a control circuit board and a connector circuit board. The control circuit board is embedded into a side of the housing, and the control circuit board and the connector circuit board are mutual connected using a connector interface to provide electric conductance therebetween. Accordingly, when the connector circuit board is damaged, then the connector circuit board is directly separated from the control circuit board, thereby achieving convenient extraction and facilitating use by a user.

### BACKGROUND OF THE INVENTION

(a) Field of the Invention

The art of the present invention provides a multimedia multifunctional photo combination device, and more particularly to a control circuit board and a connector circuit board that are mutual connected using a connector interface to provide electric conductance therebetween.

(b) Description of the Prior Art

Because access devices of prior art multimedia devices are embedded within the multimedia devices, thus, the entire multimedia device must be disassembled for repairs when the access device is damaged, causing annoyance to the user and waste of cost.

Furthermore, memory card slots of prior art multimedia devices which provide for the insertion of readable devices have a single specification. If the user wants to use a readable device of another specification, then the readable device cannot be inserted, moreover, the memory card slots do not support reading of readable devices of relatively high capacity. Moreover, restrictions are imposed by the design of the multimedia device itself, thereby preventing separately extending the transmission interfaces, causing inconvenience to the user; what is more, compatibility of the multimedia device is low, and manufacturing cost is high.

Hence, the inventor of the present invention proposes to resolve and surmount existent technical difficulties to eliminate the aforementioned shortcomings of prior art.

### SUMMARY OF THE INVENTION

The art of the present invention provides a multimedia multifunctional photo kiosk combination device, and more particularly to a control circuit board and a connector circuit board that are mutual connected using a connector interface to provide electric conductance therebetween. Hence, when the connector circuit board is damaged, the connector circuit board can be directly separated from the control circuit board, thereby achieving the objectives of convenient extraction and facilitating use by a user.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of the present invention.

FIG. 2 shows an exploded elevational view of the present invention.

FIG. 3 shows a first view of an embodiment according to the present invention.

FIG. 4 shows a second view of an embodiment according to the present invention.

FIG. 5 shows a third view of the embodiment according to the present invention.

FIG. 6 shows a fourth view of an embodiment according to the present invention.

FIG. 7 shows a fifth view of an embodiment according to the present invention.

FIG. 8 shows a sixth view of an embodiment according to the present invention.

### DETAILED DESCRIPTION OF THE PREFERRED EMBODIMENTS

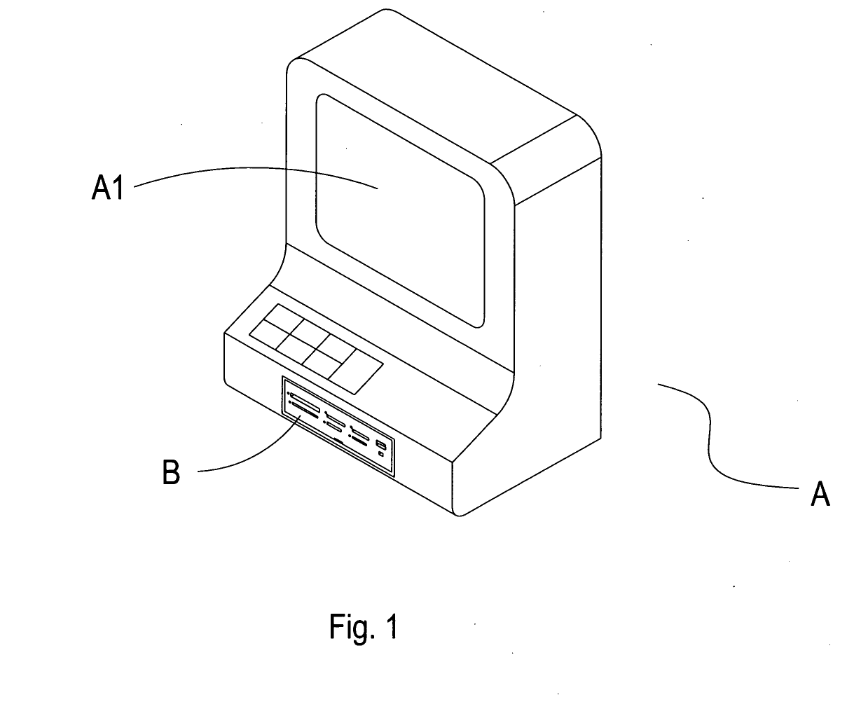

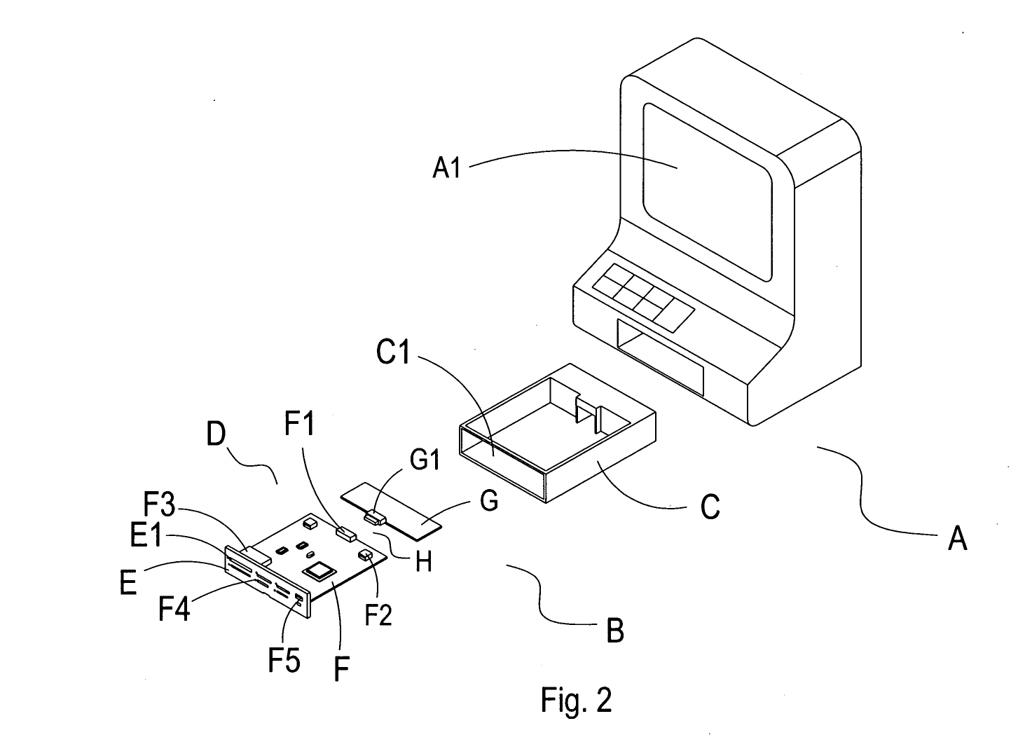

The present invention provides a multimedia multifunctional photo kiosk combination device, as depicted in FIG. 1 and FIG. 2, wherein a multimedia device A is structured to comprise a display interface A1 and an access device B.

The multimedia device A is configured with the display interface A1 which enables a user to operate the multimedia device A, and the access device B of the multimedia device A is structured to comprise a housing C and a connector module D. The connector module D of the access device B comprises a control circuit board G and a connector circuit board F, and one side of the control circuit board G of the connector module D is configured with a first connector G1 corresponding to a second connector F1 of the connector circuit board F. Moreover, the control circuit board G of the connector module D is embedded into a side of the housing C, and one side of the housing C of the access device B is configured with an embedding slot C1. The embedding slot C1 enables the connector circuit board F of the connector module D to be disposed and clamped therein.

One side of the connector circuit board F of the connector module D is configured with a plurality of expansion devices F2, a plurality of memory card slots F3, a plurality of indicator lights F4 and transmission interfaces F5, moreover, a faceplate E is located at another side of the connector circuit board F corresponding to the memory card slots of F3 of the connector circuit board F, and the faceplate E of the connector circuit board F is configured with a plurality of insertion slots E1 corresponding to the memory card slots F3. Furthermore, one area of the connector circuit board F of the connector module D is configured with the second connector F1 corresponding to the first connector G1 of the control circuit board G.

The memory card slots F3 of the connector circuit board F have a plurality of different specifications, and the connector circuit board F is configured with the plurality of indicator lights F4. The plurality of indicator lights F4 of the connector circuit board F correspond to the plurality of memory card slots F3 of different specifications of the connector circuit board F.

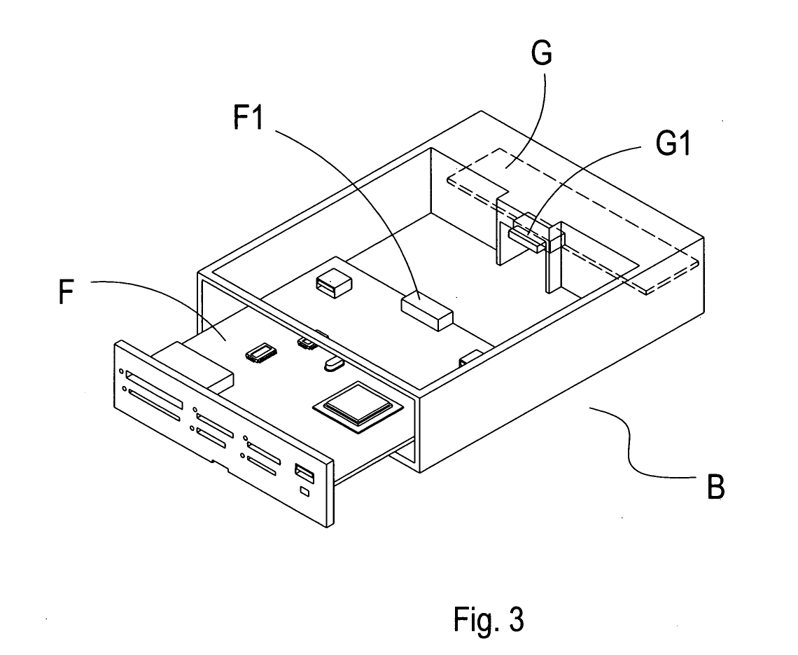

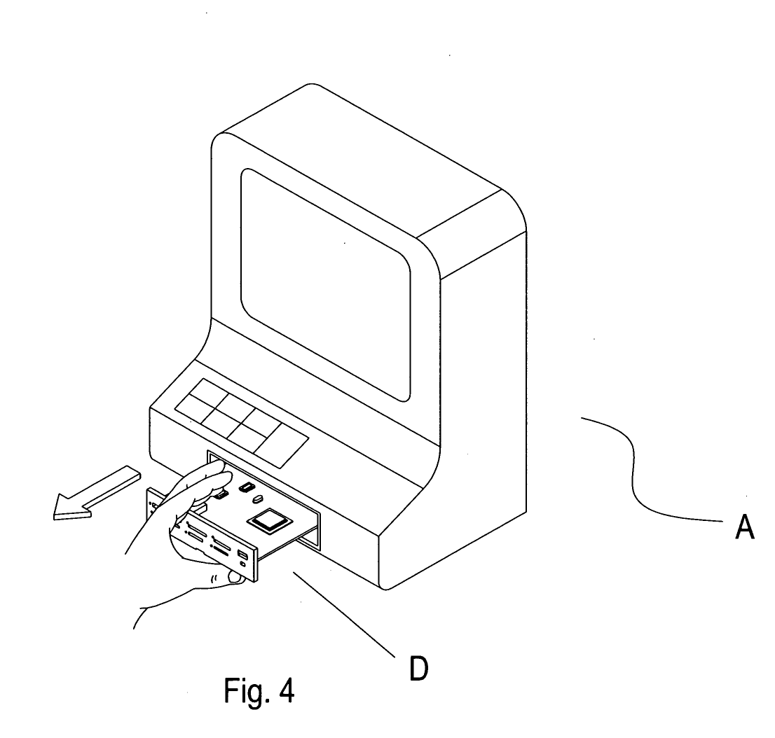

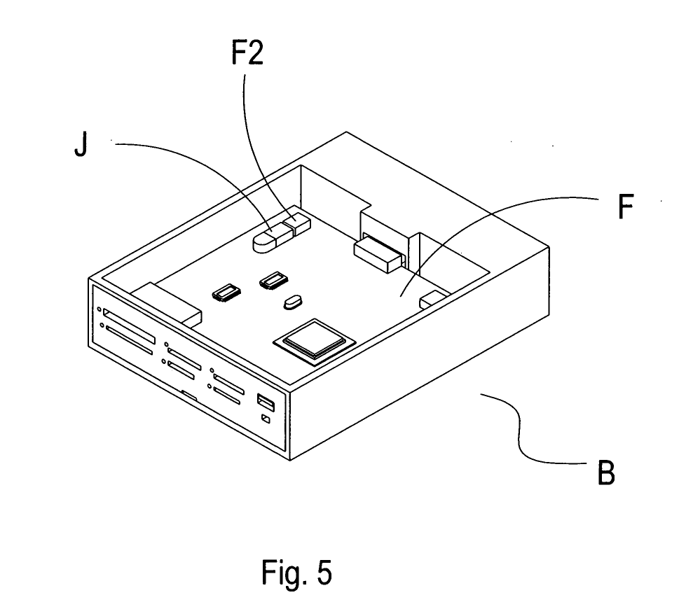

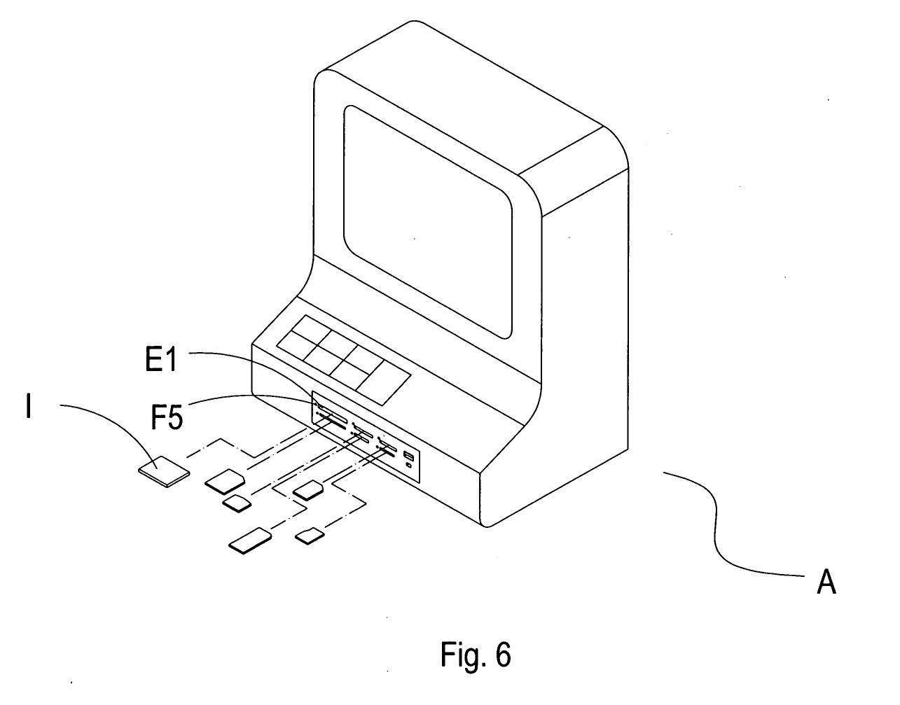

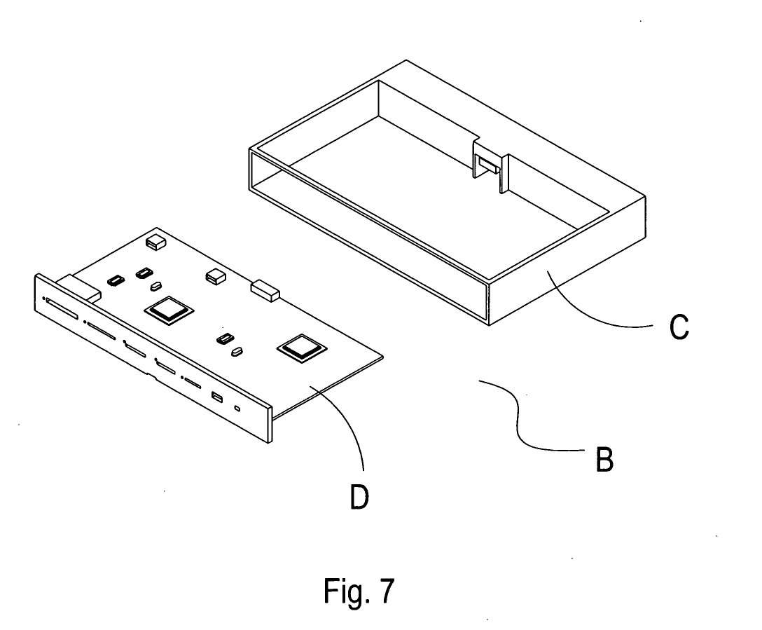

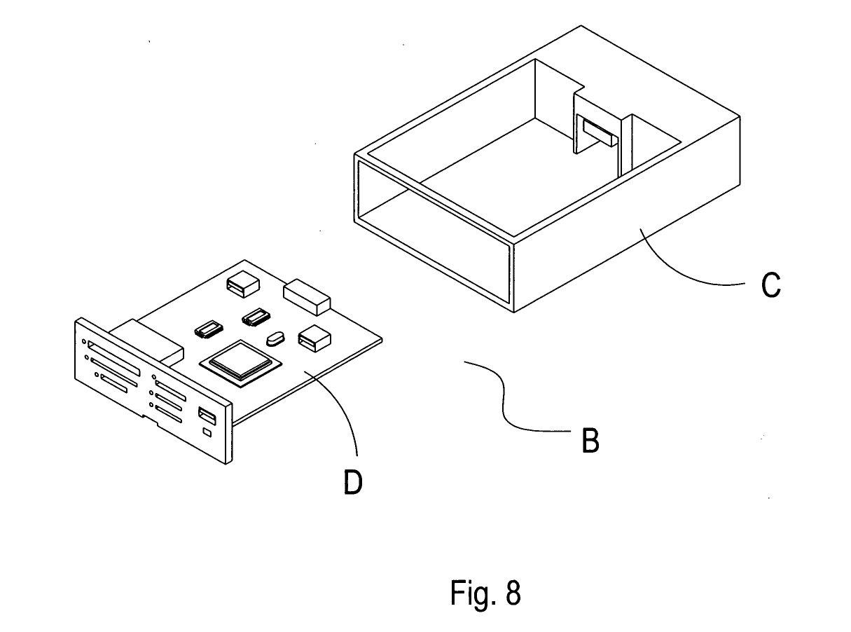

Referring to FIG. 2, FIG. 3, FIG. 4, FIG. 5, FIG. 6, FIG. 7 and FIG. 8, which show embodiments of the multimedia multifunctional photo kiosk combination device as provided by the present invention, wherein the multimedia device A enables the user to develop photographs and provides diverse multimedia services. Moreover, the user is able to use diverse access interfaces to transmit data needed to be transmitted to the multimedia device A.

The access device B is installed in the multimedia device A, and the housing C of the access device B clamps the connector module D therein; moreover, the connector circuit board F of the connector module D and the control circuit board G are mutually connected using a connector interface H to provide electrical conductance therebetween. Accordingly, when the connector circuit board F is damaged, then the connector circuit board F of the connector module D can be directly separated from the control circuit board G, thereby achieving convenient extraction of the connector circuit board F and facilitating use by a user.

Hence, when using the present invention, the user does not need to first insert a readable device I into the memory card slot F3, but can first select the specifications of the readable device I required from the display interface A1 of the multimedia device A, whereupon the indicator light F4 for the readable device I specifications selected by the user lights up, at which time, the readable device I need only be inserted into the memory card slot F3 corresponding to the lit indicator light F4. Accordingly, data needed to be transmitted can then be transmitted to the multimedia device A, thereby enabling the user to proceed with multimedia services required via the display interface A1 of the multimedia device A.

The connector interface H can be configured as an IDE (integrated drive electronics) interface, a SATA (serial advanced technology attachment) interface, a USB (universal serial bus), an IEEE 1394 interface (IEEE 1394 Institute of Electrical and Electronic Engineers Standard Bus Interface), a PCI-E (Peripheral Component Interconnect Express) interface, an express card, and related connector interfaces able to achieve connection.

The connector circuit board F is configured with the plurality of expansion devices F2, moreover, the expansion devices F2 can be separately installed with expansion members J, thereby achieving the objective of extending the transmission interfaces F5. The expansion members J can be configured as wireless devices, printer ports, blue-tooth, flash drives, credit card card readers and related expansion members able to transmit data.

The connector circuit board F of the connector module D is configured with the memory card slots F3 having a plurality of specifications and the plurality of transmission interface F5, moreover, the memory card slots F3 of the connector circuit board F enable the readable devices I of diverse specifications to be inserted therein for use thereof. The readable devices I include the CF card (Compact Flash Memory Card), the MS card (Memory Stick Memory Card), the SD card (Secure Digital Memory Card), the Mini SD card (Mini Secure Digital Memory Card), the Micro SD card (Micro Secure Digital Memory Card), the MMC card (Multi Media Memory Card), the RSMMC card (Reduced Size Multi Media Memory Card), the SM card (Smart Media Memory Card), the XD card (xD-Picture Card), the M2 card (MS Micro Card) and the MMC Micro card (Multi Media Memory Card Micro), thereby facilitating inserting the readable devices I of diverse specifications.

Furthermore, the plurality of transmission interfaces F5 of the connector circuit board F can be configured as USB (Universal Serial Bus) ports, IrDA (Infra-red Data Association) devices, blue-tooth interfaces and related interfaces able to achieve transmission of data.

The connector circuit board F is configured with the plurality of indicator lights F4, and the indicator lights F4 of the connector circuit board F correspond to the respective memory card slots F3 of the connector circuit board F, which enables the indicator lights F4 of the connector circuit board F to light up when the readable devices I are inserted into the memory card slots F3 of the connector circuit board F, and accordingly enable distinguishing whether or not there is electrical conductance between the readable devices I and the connector circuit board F.

The access device B can be configured with 3.5 inch, 5.25 inch and a plurality of other size specifications, and can be used in a desktop computer, a notebook computer and related devices.

In order to better explicitly disclose advancement and practicability of the present invention, a comparison with prior art is described hereinafter:

### SHORTCOMINGS OF PRIOR ART

1. The access device is embedded within the multimedia device.

2. Because of shortcoming 1, maintenance or exchange is inconvenient.

3. Only provided with memory card slots of single specification, and thus unable to support reading of readable devices having relatively large capacity.

4. Because of restrictions imposed by the design of the multimedia device itself, thus, the prior art prevents separately extending the transmission interfaces.

5. Troublesome to the user and manufacturing cost is high; moreover, compatibility of the multimedia device is low.

### ADVANTAGES OF THE PRESENT INVENTION

1. The control circuit board G and the connector circuit board F are mutual connected using the connector interface H to provide electric conductance therebetween.

2. Configured with the memory card slots F3 having diverse specifications.

3. Because of advantage 1, thus, achieves convenient extraction of the connector circuit board F and facilitates use by a user.

4. Because of advantage 2, thus, inserting of readable devices having diverse specifications is facilitated.

5. The expansion devices F2 of the connector circuit board F enable achieving the objective of providing extensible transmission interfaces.

6. Because of advantage 5, thus, compatibility of the access device B is increased.

7. Convenient for the user to operate, and achieves the objective of saving on cost and man-hours.

8. Provided with advancement and practicability.

9. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multimedia multifunctional photo kiosk combination device, wherein a multimedia device comprises a display interface and an access device;
the access device comprises a housing and a connector module, and the connector module comprises a control circuit board and a connector circuit board; the control circuit board is embedded into a side of the housing, wherein, when the connector circuit board is damaged, then the connector circuit board is directly separated from the control circuit board, thereby achieving convenient extraction and facilitating use by a user.

2. The multimedia multifunctional photo kiosk combination device according to claim 1, wherein the multimedia device enables a user to develop photographs and provides diverse multimedia services, moreover, the user is able to use diverse access interfaces to transmit data needed to be transmitted to the multimedia device.

3. The multimedia multifunctional photo kiosk combination device according to claim 1, wherein a connector interface is configured as an IDE (integrated drive electronics) interface, a SATA (serial advanced technology attachment) interface, a USB (universal serial bus), an IEEE 1394 interface (IEEE 1394 Institute of Electrical and Electronic Engineers Standard Bus Interface), a PCI-E (Peripheral Component Interconnect Express) interface, an Express Card, and related connector interfaces able to achieve connection.

4. The multimedia multifunctional photo kiosk combination device according to claim 1, wherein the connector circuit board is configured with a plurality of memory card slots, a plurality of expansion devices, a plurality of indicator lights and transmission interfaces, and a faceplate is located at another side of the connector circuit board corresponding to the memory card slots.

5. The multimedia multifunctional photo kiosk combination device according to claim 4, wherein the expansion devices are installed with expansion members, the expansion members being configured as wireless devices, printer ports, blue-tooth, flash drives, credit card card readers and related expansion members able to transmit data.

6. The multimedia multifunctional photo kiosk combination device according to claim 4, wherein the memory card slots of the connector circuit board are configured to enable readable devices to be inserted therein, including the CF card (Compact Flash Memory Card), the MS card (Memory Stick Memory Card), the SD card (Secure Digital Memory Card), the Mini SD card (Mini Secure Digital Memory Card), the Micro SD card (Micro Secure Digital Memory Card), the MMC card (Multi Media Memory Card), the RSMMC card (Reduced Size Multi Media Memory Card), the SM card (Smart Media Memory Card), the XD card (xD-Picture Card), the M2 card (MS Micro Card), the MMC Micro card (Multi Media Memory Card Micro), and related readable cards able to be inserted into the memory card slots for use thereof.

7. The multimedia multifunctional photo kiosk combination device according to claim 4, wherein a plurality of insertion slots are defined in the faceplate.

8. The multimedia multifunctional photo kiosk combination device according to claim 4, wherein the transmission interfaces are configured as USB (Universal Serial Bus) ports, IrDA (Infra-red Data Association) devices, blue-tooth interfaces and related interfaces able to achieve transmission of data.

9. The multimedia multifunctional photo kiosk combination device according to claim 1, wherein the connector interface is configured with a first connector and a second connector; the first connector is disposed at one side of the control circuit board, and the second connector is disposed at one side of the connector circuit board.

10. The multimedia multifunctional photo kiosk combination device according to claim 1, wherein the access device is further configured with 3.5 inch, 5.25 inch and a plurality of specifications, and is applicable for use in a desktop computer, a notebook computer and related devices.
